(19) United States
(12) Patent Application Publication
(10) Pub. No.: US 2026/0261077 A1
(43) Pub. Date: Sep. 3, 2026

(54) CABLE PLUG CONNECTOR WITH INTERNAL LOCKING ELEMENT

(71) Applicant: Neutrik AG, Schaan (LI)

(72) Inventors: Sebastian FRENZEL, Amtzell (DE); Marco MANGENG, Dalaas (AT); Lana-Simone UNGER-NIEDRIG, Azmoos (CH)

(73) Assignee: Neutrik AG, Schaan (LI)

(21) Appl. No.: 19/547,950

(22) Filed: Feb. 24, 2026

(30) Foreign Application Priority Data
Mar. 3, 2025 (EP) 25161330.3

(51) Int. Cl. H01R 13/627; H01R 13/52

(52) U.S. Cl. CPC H01R 13/6271; H01R 13/5205

(57) ABSTRACT

A cable plug connector for providing a mechanically lockable plug connection with a counterpart built-in plug connector matched thereto. The cable plug connector includes a plug body with a coupling portion, that is insertable into an opening of the built-in plug connector to provide the plug connection, and a receiving cavity extending in an outer wall of the plug body. The receiving cavity is configured as a half-shell with a passage to an interior of the plug body. A mechanical retaining element includes a connecting part that connects a locking part with an actuating part. The mechanical retaining element is arranged in the receiving cavity with the actuating part protruding from the receiving cavity perpendicular to a center axis of the plug body, and the connecting part extends through the passage of the plug body, so that the locking part is located in the interior of the plug body.

### CROSS-REFERENCE TO RELATED APPLICATIONS

This application claims priority from European Patent Application No. 25161330.3, filed Mar. 3, 2025, which is incorporated herein by reference as if fully set forth.

### FIELD OF THE INVENTION

The present invention relates to a cable plug connector configured for providing a mechanically lockable plug connection with a built-in plug connector matched to the cable plug connector as a counterpart.

### BACKGROUND OF THE INVENTION

Lockable cable plug connections are known from the prior art. In this context, cable plug connectors with a locking slider are generally used, wherein the locking slider is pushed forward after the coupling portion of the cable plug connector has been inserted into the opening of the built-in plug connector, whereby a locking element attached to the locking slider engages in a corresponding locking element counterpart located above the insertion opening on the built-in plug connector and thus locks the plug connection between the cable plug and built-in plug.

The advantage of this type of locking mechanism is that it is easy to operate. However, there are also connector types for which such a locking mechanism cannot be used because, for example, the area above the insertion opening on the built-in plug connector is occupied by other structures, or a corresponding connector type requires the locking element at a very specific point in order for the locking mechanism to function.

For example, there are cable plugs in which the locking element must be located inside the plug body in order to provide the desired locking mechanism. With these cable plugs, however, the problem often arises that due to the plug insert, which has the contact elements, the cable, any fixing structures and possibly also sealing structures inside the plug body, there is hardly any space left for the locking element or a mechanical retaining element that comprises the locking element. This mechanical retaining element is therefore “built around” the other structures, making it very difficult to lock or unlock the locking mechanism from outside the cable plug.

Thus, there is a need for cable plugs in which the locking element is located inside the plug body while still allowing easy locking and unlocking from the outside, in particular without having to completely rebuild the entire inner structure of the cable plug, especially structures such as the plug insert.

### SUMMARY

It is therefore an object of the invention to provide a cable plug connector that overcomes the disadvantages of the state of the art.

It is a further object of the invention to provide a cable plug connector which enables easy locking and unlocking of a locking mechanism from outside the cable plug connector.

It is a further object of the invention to provide a cable plug connector with an improved mechanical retaining element.

These objects are achieved by realizing at least part of the features disclosed herein. Features which further develop the invention in an alternative or advantageous manner are described below and in the claims.

The present invention relates to a cable plug connector configured for providing a mechanically lockable plug connection with a built-in plug connector matched to the cable plug connector as a counterpart.

The cable plug connector comprises a plug body, wherein the plug body comprises a coupling portion, wherein the coupling portion is provided to be inserted into an opening of the built-in plug connector to provide the plug connection, and a receiving cavity extending in an outer wall of the plug body, wherein the receiving cavity is configured as a half-shell with a passage/opening to an interior/internal space of the plug body.

The cable plug connector further comprises a mechanical retaining element comprising a locking part, an actuating part and a connecting part connecting the locking part with the actuating part.

The mechanical retaining element is arranged in/within the receiving cavity such that the actuating part protrudes from/out of the receiving cavity in a direction perpendicular to a center axis/central axis of the plug body, and the connecting part extends/passes through the passage of the plug body, so that the locking part is located/positioned in the interior of the plug body.

The inventive cable plug connector has the advantage over prior art cable plug connectors that the locking part is arranged/located in the interior of/inside the plug body while still allowing easy locking and unlocking from the outside. This means that the actuating part can be operated/actuated/activated/pressed from the outside of the cable plug connector (even when plugged in), allowing precise control of the position of the locking part inside the plug body by means of the interaction/interplay between the actuating part and the connecting part. The internal structure of the cable plug, in particular structures such as the plug insert, does not need to be modified, or only to a very limited extent.

As the cable plug connector according to the invention comprises a (substantially) cylindrical shape, the outer wall of the plug body can also be described as the lateral surface or the jacket of the plug body, wherein the jacket of the plug body runs around a center axis/central axis of the plug body. As usual for the description of cylindrical bodies, the direction of the course of this center axis and thus the direction of the longitudinal extension of the jacket of the plug body corresponds to the axial direction of the plug body. In this case, the direction of insertion of the cable plug connector into the opening of the built-in plug connector also corresponds to the axial direction.

In an exemplary embodiment of the cable plug connector according to the invention, the mechanical retaining element can be configured to provide a locking mechanism in that the locking part engages in a retaining element counterpart of the built-in plug connector and is blocked with respect to an axial movement in a cable plug connector extraction direction.

The locking part can be configured as a kind of protrusion/projection/hook that engages in a corresponding recess/depression/cavity in the built-in plug connector and thus, if the locking mechanism is not released, strikes the recess when the cable plug connector is pulled out of the built-in plug connector, thus preventing the cable plug connector from being pulled out unplanned. This embodiment has the advantage that the cable plug connector cannot be torn out of the plug connection with the built-in plug connector, e.g. if a person trips over the cable and pulls on the cable accordingly.

In this embodiment, the cable plug connector according to the invention can be locked in the plugged-in state in a built-in plug connector/chassis socket configured as a counterpart in such a way that contact elements of the cable plug connector are in contact with contact element counterparts of the built-in plug connector and, in addition, accidental removal of the cable plug connector is prevented.

In a further embodiment of the cable plug connector, the locking part can be formed as a projection extending from the connecting part in a direction perpendicular to the central axis of the plug body towards the central axis of the plug body. The projection can be provided to engage in a retaining element counterpart of the built-in plug connector.

The expressions “perpendicular to the axial direction of the central axis” as well as “perpendicular to the central axis” are not necessarily to be understood in the context of this application as being exactly perpendicular, but rather as offering a certain amount of freedom for deviation. For example, when pressure is exerted on the actuating part, the mechanical retaining element moves towards, in particular into, the receiving cavity in accordance with a pivoting movement about an pivot axis extending through the contact point of the connecting part with the first edge and raises from, in particular rises out of, the receiving cavity accordingly with a pivoting movement about this pivot axis when this pressure is removed. Consequently, the movement performed by the locking part also corresponds to such a pivot movement, which largely corresponds to a movement perpendicular to the axial direction of the central axis/perpendicular to the central axis, but may deviate slightly from an exactly perpendicular movement depending on the design of the components concerned. Furthermore, it is possible that the relevant components of the cable connector according to the invention are mounted with some “play”, i.e. can move slightly back and forth, which can also lead to deviations from an exactly perpendicular movement.

In a further exemplary embodiment of the cable plug connector according to the invention, the mechanical retaining element can be arranged in the receiving cavity such that the connecting part rests with a side facing the interior of the plug body on a first edge formed by a bottom of the receiving cavity and the passage, so that the mechanical retaining element is pivotable about a contact point of the side of the connecting part with the first edge.

In a further embodiment of the cable plug connector, the side of the connecting part facing the interior of the plug body can comprise an obliquely ascending course starting from the actuating part to the contact point with the first edge.

In a further exemplary embodiment of the cable plug connector according to the invention, the mechanical retaining element can be pivotable about the contact point such that
if the actuating part is pressed towards the receiving cavity, the locking part is moved further away from the center axis of the plug body and closer to an inner wall of the interior of the plug body; and/or
if the locking part is pressed further away from the center axis of the plug body and closer to the inner wall of the interior of the plug body, the actuating part is moved towards the receiving cavity; and/or
if the actuating part is raised from the receiving cavity, the locking part is moved further away from the inner wall of the interior of the plug body and closer to the center axis of the plug body; and/or
if the locking part is moved further away from the inner wall of the interior of the plug body and closer to the center axis of the plug body, the actuating part is raised from the receiving cavity.

In a further embodiment of the cable plug connector, the locking part—seen from the coupling portion in the axial direction of the center axis of the plug body—can be configured obliquely ascending. The locking part can be configured such that during insertion of the coupling portion into the opening of the built-in plug connector, an edge arranged inside the built-in plug connector, in particular an edge of the retaining element counterpart of the built-in plug connector, slides along the obliquely ascending locking part, so that the locking part can be pressed further away from the center axis of the plug body and closer to the inner wall of the interior of the plug body until the locking part of the mechanical retaining element has reached the retaining element counterpart of the built-in plug connector such that the locking part can engage in the retaining element counterpart of the built-in plug connector to provide the locking mechanism.

These embodiments have the advantage that the mechanically lockable plug connection between cable plug connector and built-in plug connector can be provided very easily.

In a further exemplary embodiment of the cable plug connector according to the invention, the connecting part can comprise on a side facing away from the interior of the plug body an elevation. The mechanical retaining element can be arranged in the receiving cavity such that the elevation rests on a second edge formed by the inner wall of the interior of the plug body and the passage, so that the mechanical retaining element can be blocked with respect to a movement in axial direction of the center axis of the plug body towards the coupling portion; and/or a range of a pivoting movement of the mechanical retaining element around the contact point can be limited.

In a further embodiment of the cable plug connector, the cable plug connector can further comprise a fastening element configured to fasten the mechanical retaining element in its arrangement in the receiving cavity. The fastening element can pass through the receiving cavity perpendicular to the center axis of the plug body, so that the mechanical retaining element can be positioned between the bottom of the receiving cavity and the fastening element; and a range of a pivoting movement of the mechanical retaining element around the contact point can be limited.

In a further embodiment of the cable plug connector, the fastening element can extend/pass through the receiving cavity perpendicular to the center axis of the plug body, such that the actuating part is located on one side of the fastening element and the elevation of the connecting part is located in the axial direction of the center axis of the plug body on an opposite side of the fastening element.

In a further embodiment of the cable plug connector, the fastening element can be configured as a ring surrounding the plug body in a plane perpendicular to the central axis of the plug body.

In a further embodiment of the cable plug connector, the cable plug connector can further comprise a covering element arranged on the outer wall of the plug body. The covering element can cover the receiving cavity and the passage to the interior of the plug body such that a penetration of water and/or gas from an area outside the cable plug connector through the passage into the interior of the plug body is prevented.

This embodiment has the advantage that the receiving cavity and thus the interior of the plug body is sealed with respect to the outside of the cable plug. Thus, the plug contacts/contact pins located in the interior of the cable plug connector are protected against corrosion or a short circuit, in particular due to (air) moisture, when the cable plug connector is inserted into a built-in plug connector. At the same time, the locking mechanism can be easily activated and deactivated from outside the cable plug connector.

Optionally, the covering element can comprise an elastically deformable material, in particular rubber.

In a further embodiment of the cable plug connector, the covering element can comprise the fastening element.

Optionally, the fastening element can be configured as a beam extending perpendicular to the center axis of the plug body through the receiving cavity.

In a further embodiment of the cable plug connector, the covering element can comprise an activation area. The activation area can protrude from the outer wall of the plug body, so that the actuating part can be located between the covering element and the receiving cavity such that when the activation area is pressed in a direction perpendicular to the central axis of the plug body towards the receiving cavity, the actuating part is pressed towards the receiving cavity.

In a further embodiment of the cable plug connector, the cable plug connector can further comprise a plug insert arranged in the interior of the plug body. The plug insert can be provided to accommodate a contact element, wherein the contact element can be provided to contact a contact element counterpart on the built-in plug connector side by entering the plug connection and thus to provide signal transmission over the plug connection. The plug insert can be configured such that the cable plug connector comprises one of the following cable plug connector types: a two-pole or three-pole or four-pole power plug connector type (for example, a powerCON plug from the company Neutrik AG from Liechtenstein), SPE, USB-C, IEC, XLR (with two poles or three poles or four poles or more than four poles), RJ45, HDMI, USB, RCA, or Fiber Optical Ferrule.

The inventive cable plug connector is advantageously configured in such a way that the locking mechanism provided by the mechanical retaining element and optionally the sealing effect provided by the covering element and/or the seal is independent of the specific configuration/design of the plug insert respectively the contact elements mounted therein. In this way, the inventive cable plug connector can be used for different connector types.

Because the cable plug connector according to the invention obtains its plug type through the plug insert/inlet, the cable plug connector can be configured substantially identical around this plug insert for each plug type, which means that many steps in the assembly of the cable plug connector can be carried out in one production line. Furthermore, the same assembly parts can be used for a large number of different connector types.

In a further embodiment of the cable plug connector, the cable plug connector can further comprise a fixation unit arranged in the interior of the plug body. The fixation unit can be configured to fix the plug insert and/or a cable contacted with the contact element received by the plug insert in the interior of the plug body.

In a further embodiment of the cable plug connector, the fixation unit can comprise a thread. The thread can be arranged on an outer wall of the fixation unit.

In a further embodiment of the cable plug connector, the cable plug connector can further comprise a union nut. The union nut can be arranged at the plug body at an end of the plug body opposite the coupling portion in axial direction of the center axis of the plug body. The union nut can comprise a thread on an outer wall of the union nut.

In a further embodiment of the cable plug connector, the union nut can be screwed onto the thread of the fixation unit.

In a further embodiment of the cable plug connector, the cable plug connector can further comprise a seal. The seal can comprise a cable passage extending through the seal. The cable passage can extend between a first and a second seal opening within the seal.

Optionally, the seal can be arranged at an end of an union nut opposite a contact area of the union nut with the plug body in axial direction of the center axis of the plug body.

In a further embodiment of the cable plug connector, the cable plug connector can further comprise a bushing. The bushing can be configured such that—if the bushing is screwed onto the thread of the union nut and if a cable is passed through the cable passage of the seal—the bushing presses on the seal so that the seal can be contacted with the cable passed through the cable passage.

In a further embodiment, the seal can be contacted with the cable passed through the cable passage in a watertight and/or airtight manner. Depending on the configuration of the bushing and the seal, the cable plug connector can be sealed in such a way that it fulfills the requirements of protection class IP65, IP66 and/or IP67.

On the one hand, this additionally prevents the penetration of water and/or air on the back end of the cable plug connector, particularly in the area of a cable entry opening, and on the other hand, the cable inserted into the cable plug connector through the cable entry opening is additionally supported or protected from bending/breaking by the bushing and/or seal.

In a further embodiment, the bushing can comprise a bushing cavity extending between a first and a second bushing opening within the bushing.

In a further embodiment, the seal can be arranged within the bushing cavity such that the first and second bushing opening and the first and second seal opening—seen in axial direction of a center axis of the cable plug connector—comprise a concentric arrangement with respect to each other. This makes it very easy to pass the cable through the arrangement of the bushing and the seal and insert the cable into the interior of the plug body

In a further embodiment of the cable plug connector, the cable plug connector can further comprise a tensioning element. The tensioning element can exert such a pretension on the mechanical retaining element that the actuating part protrudes from the receiving cavity in the direction perpendicular to the center axis of the plug body.

In a further embodiment of the cable plug connector, the tensioning element can be configured as a spring, a compressible plastic, a compressible sponge-like material, or a compressible foam-like material.

In a further embodiment of the cable plug connector, the receiving cavity can comprise a stop. The actuating part can be moved towards the receiving cavity to such an extent that the actuating part hits the stop.

In a further embodiment of the cable plug connector, the receiving cavity can comprise a dividing wall which separates the receiving cavity into two parts. A first of the two parts of the receiving cavity which is more distant from the coupling portion in axial direction of the center axis of the plug body, can comprise the tensioning element. Further, a second of the two parts of the receiving cavity, which is less distant from the coupling portion in axial direction of the center axis of the plug body, can comprise the passage to the interior of the plug body.

Optionally, the dividing wall can extend/pass through the receiving cavity perpendicular to the axial direction of the center axis of the plug body

Optionally, the mechanical retaining element can be arranged in the second of the two parts of the receiving cavity.

In a further embodiment of the cable plug connector, the tensioning element can extend from the bottom of the receiving cavity into a recess of the actuating part such that the tensioning element abuts against a bottom of said recess, so that the pretension can be exerted on the mechanical retaining element. By applying pressure on the actuating part, the tensioning element can be compressible such that the actuating part can be moved towards the receiving cavity, so that the locking part can be moved further away from the center axis of the plug body and closer to the inner wall of the interior of the plug body, so that, if the locking part engages in the retaining element counterpart, the locking part can be moved out of the retaining element counterpart.

These embodiments of the cable plug connector according to the invention have the advantage that the mechanical retaining element is positioned movably in the receiving cavity such that if the locking part hits a stop in the built-in plug connector (e.g. an edge of the opening of the built-in plug connector) when the coupling portion is inserted into the opening of the built-in plug connector, the locking part and thus the connecting part is automatically pressed towards the inner wall of the plug body, while the tensioning element located under the actuating part of the mechanical retaining element is compressed.

As soon as the coupling portion has reached the intended position in the built-in plug connector, which may be the case, for example, when the locking part has reached below the recess of the built-in plug connector configured to receive the locking part, the pressure on the locking part and thus on the mechanical retaining element is reduced, the tensioning element automatically expands again and the locking part is moved into the recess, which activates the locking mechanism. To unlock the locking mechanism again, pressure can be exerted on the actuating element, which compresses the tensioning element again causing the locking part to move out of the recess of the built-in plug connector.

In a further embodiment of the cable plug connector, the inner wall of the interior of the plug body can comprise a recess in the region of the coupling portion. The locking part can be moved into the recess in the course of a pivoting movement of the connecting part about the contact point with the first edge.

In a further embodiment of the cable plug connector, a depth of the recess of the inner wall of the interior of the plug body can increase from the passage in axial direction of the center axis of the plug body towards a front portion of the coupling portion. The coupling portion can be provided to be inserted with the front portion first into the opening of the built-in plug connector.

### BRIEF DESCRIPTION OF THE DRAWINGS

The invention is illustrated in more detail below, purely by way of example, with reference to working examples shown schematically in the drawing. Identical elements are labelled with the same reference numerals in the figures. The described embodiments are generally not shown true to scale and they are also not to be interpreted as limiting the invention. Specifically,

FIG. 1: shows a schematic illustration of the cable plug connector according to the invention;

FIGS. 2 & 3: show different perspectives of a longitudinal section through the cable plug connector according to the invention.

### DETAILED DESCRIPTION

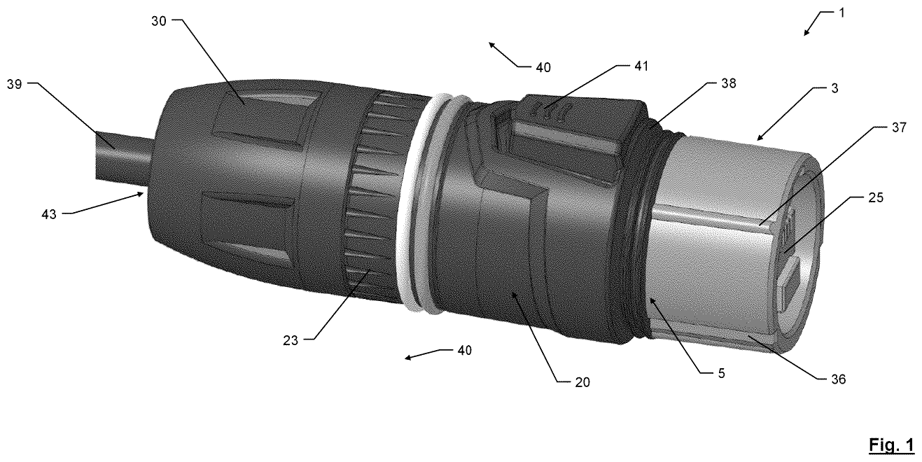

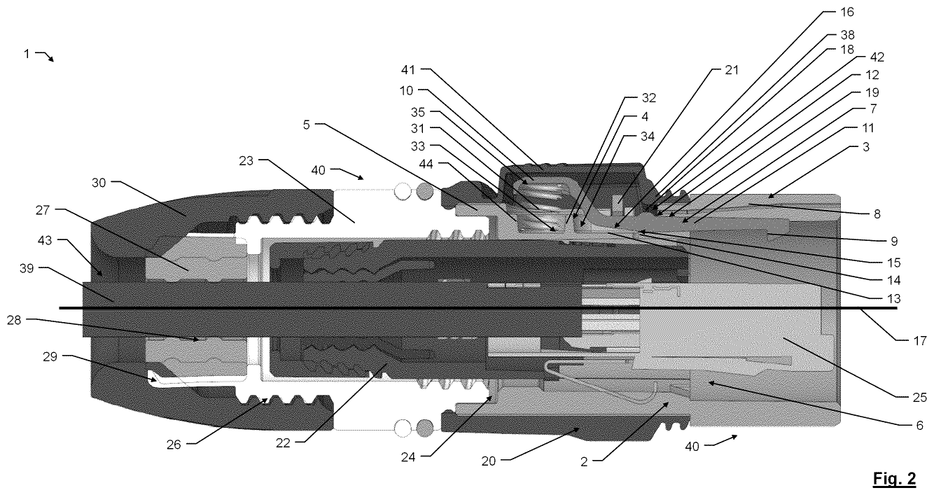

FIG. 1 shows a schematic illustration of the cable plug connector 1 according to the invention. In addition to the plug body 2, the cable plug 1 comprises the union nut 23 attached to the rear end 24 of the plug body 2 (the end of the plug body opposite the coupling part 3), which provides a receiving space for the fixation unit 22 and for the cable 39.

The cable plug connector 1 further comprises a covering element/ceiling element/sealing element 20 arranged on the outer wall 5 of the plug body 2, wherein the covering element 20 covers the receiving cavity 4 and the passage 12 to the interior 6 of the plug body 2 such that a penetration of water and/or gas from an area 40 outside the cable plug connector 1 through the passage 12 into the interior 6 of the plug body 2 is prevented.

The covering element 20 is made of an elastically deformable material, so that on the one hand the covering element can be “pulled” tightly onto the plug body 2, thus achieving the desired sealing effect, and on the other hand the user can press in the activation area 41 of the covering element 20 and thus actuate the actuating part 10 of the mechanical retaining element 7 located underneath.

To prevent the locking part 9 from being pushed too deeply into the built-in plug connector beyond the recess and also to ensure that the RJ45 contacts can make faultless contact with the counter-contacts, the covering element 20 forms an elevation 38 that at least partially surrounds the plug body 2 and forms a stop that prevents the plug body 2 from being pushed too deeply into the built-in plug connector past the coupling portion 3. The stop 38—seen from the coupling portion 3 in axial direction of the center axis 17 of the plug body 2—lies behind the coupling portion 3.

In order to ensure that the cable plug connector 1 can be inserted into the opening of the built-in plug connector in the intended rotational orientation and also to ensure that the RJ45 contacts can make faultless contact with the counter-contacts, the coupling portion has at least one guide groove 36 and/or at least one guide elevation 37, into which a corresponding guide elevation of the built-in plug connector can engage and/or which can be received by a corresponding guide groove of the built-in plug connector.

The cable plug connector 1 further comprises a bushing 30, wherein the bushing 30 further seals the interior 6 of the plug body 2 and also provides kink protection for the cable 39 inserted through the cable entry opening 43 into the interior 6 of the plug body 2.

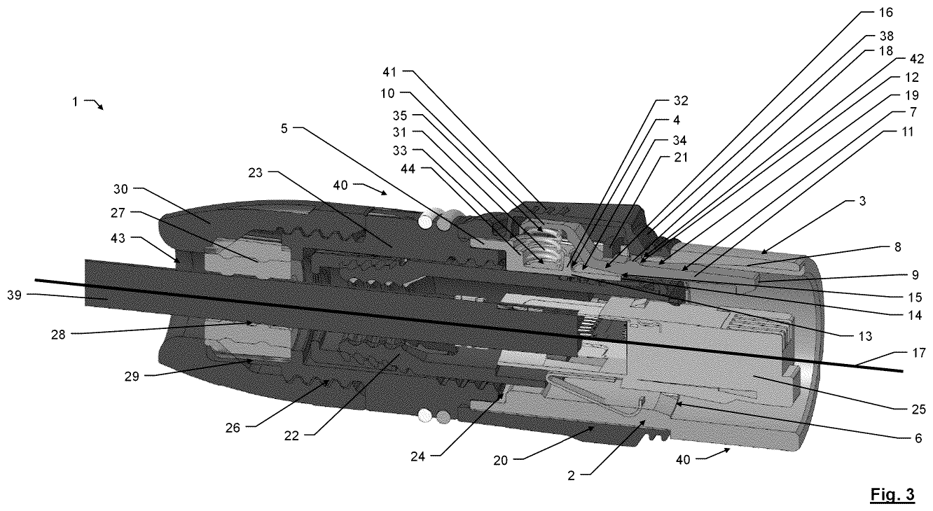

FIGS. 2 and 3 show different perspectives of a longitudinal section through an exemplary embodiment of the cable plug connector 1 according to the invention. These figures illustrate in particular that the cable plug connector 1 comprises a cylindrical plug body 2, wherein a plug insert 25 is installed in the inner cavity 6 of the plug body 2, wherein this plug insert 25 is configured in such a way that the cable connector 1 shown is an RJ45 plug. In principle, different plug inserts 25 can be inserted into the interior 6 of the plug body 2 so that the cable plug connector 1 according to the invention can have different connector types.

The contacts of the RJ45 plug shown are accessible for corresponding counter-contacts through a plug opening located in the cover surface of the cylindrical plug body 2, wherein contacting of the contacts and counter-contacts is made possible by inserting the coupling portion/section 3 into an opening of the built-in plug connector. The mechanical retaining element 7, or latch, is embedded within the receiving cavity 4 extending in an outer wall 5 of the plug body 2, wherein the receiving cavity 4—seen from the coupling portion 3 in axial direction of the center axis 17 of the plug body 2—lies behind the coupling portion 3. As it can be seen here, the receiving cavity 4 is designed as a half-shell, wherein the half-shell has a passage/opening 12 to the interior 6 of the plug body 2.

The latch 7 is configured and positioned in the receiving cavity 4 in such a way that the connecting part 11 rests with a side 16 facing the interior 6 of the plug body 2 on a first edge 14 formed by a bottom 13 of the receiving cavity 4 and the passage 12, so that the mechanical retaining element 7 is pivotable about a contact point 15 of the side 16 of the connecting part 11 with the first edge 14. The mechanical retaining element 7 has an elongated shape, wherein the latch 7 is arranged at the plug body 2 in such a way that the longitudinal axis of the connecting part 11 runs at least approximately parallel to the center 17 axis of the plug body 2.

The obliquely configured locking part 9 protrudes from the front section of connecting part 11 in a direction perpendicular to the in axial direction of the center axis 17 of the plug body 2 and is located inside the interior 6 of the plug body 2. The locking part 9 is beveled in such a way that, if the coupling portion 3 is pushed into an opening of the built-in plug connector, the locking part 9 is pushed on a stop located in this opening in such a way that the locking part 9 is pressed towards the inner wall 8 of the plug body. Due to the physical connection of the locking part 9 with the actuating part 10 via the connecting part 11, the actuating part 10 is then simultaneously moved in the direction of the receiving cavity 4. When the locking part 9 then reaches a correspondingly shaped recess in the built-in plug connector, the locking part automatically snaps inwards due to the tension exerted by the spring 31 on the latch 7 and engages in the recess, thereby providing the locking mechanism.

The actuating part 10, which can also be called a pushbutton, is located behind the connecting part 11 when viewed from the coupling portion 3 in axial direction of the center axis 17 of the plug body 2, wherein exerting pressure on this actuating part 10 compresses the spring 31 located underneath (in the recess 35), so that the mechanical retaining element 7 is pivoted about a contact point 15 of the side 16 of the connecting part 11 with the first edge 14. This pivoting movement lifts the locking part 9 out of the recess in the built-in plug and the locking mechanism can thus be released.

The shown configuration of the cable plug connector 1 includes the cylindrical plug body 2 as well as the covering element 20, the fixation unit 22, the union nut 23, the seal 27 and the bushing 30, which are at least approximately cylindrical. Furthermore, these parts of the cable plug connector 1 are arranged in such a way that the center axis 17 of the plug body 2 also runs coaxially to the center axis of the cable plug connector 1.

To prevent the latch 7 from being pressed out of the receiving cavity 4 by the pretension exerted by the spring 31 in such a way that the connecting part 11 and even the locking part 9 slip out of the passage 12 of the receiving cavity 4 and thus the latch 7 falls out of the receiving cavity 4, the cable connector 1 has the fastening element 21, which is, for example, configured as a ring or a two-legged clamp at least partially surrounding the outer wall 5 of the plug body 2 in such a way that a movement of the connecting part 11 arranged—when viewed from the coupling portion 3 along the axial direction of the center axis 17—in front of the actuating part 10 is limited and thus the latch 7 is held in the receiving cavity 4.

The connecting part 11 comprises on a side 19 facing away from the interior 6 of the plug body 2 an elevation 18, wherein the mechanical retaining element 7 is arranged in the receiving cavity 4 such that the elevation 18 rests on a second edge 42 formed by the inner wall 8 of the interior 6 of the plug body 2 and the passage 12, so that the mechanical retaining element 7 is blocked with respect to a movement in axial direction of the center axis 17 of the plug body 2 towards the coupling portion 3; and/or a range of a pivoting movement of the mechanical retaining element 7 around the contact point 15 is limited.

The receiving cavity 4 comprises a stop 44, which limits the range of motion of the actuating part 10 towards the receiving cavity 4, and a dividing wall 32, which separates the receiving cavity 4 into two parts 33, 34, wherein the first of the two parts 33 of the receiving cavity 4 which is more distant from the coupling portion 3 in axial direction of the center axis 17 of the plug body 2, comprises the tensioning element 31; and the second of the two parts 34 of the receiving cavity 4, which is less distant from the coupling portion 3 in axial direction of the center axis 17 of the plug body 2, comprises the passage 12 to the interior 6 of the plug body 2. The mechanical retaining element 7 is arranged with at least a part of the the connecting part 11 in the second of the two parts 34 of the receiving cavity.

The fixation unit 22, which is located at least partly in an inner space of the union nut 23, holds/fixes the plug insert 25 and the cable 39 contacted with the contact element received by the plug insert 25 in the interior 6 of the plug body 2. The bushing 30 is screwed onto the thread 26 of the union nut 23 and the cable 39 is passed through the cable passage 28 of the seal 27. The bushing 30 presses on the seal 27 so that the seal 27 is contacted with the cable 39 passed through the cable passage 28. The seal 27 is arranged at an end 29 of the union nut 23 opposite a contact area of the union nut 23 with the plug body 2 in axial direction of the center axis 17 of the plug body 2.

Although the invention is illustrated above, partly with reference to some preferred embodiments, it must be understood that numerous modifications and combinations of different features of the embodiments can be made. All of these modifications lie within the scope of the appended claims.

1. A cable plug connector (1) configured for providing a mechanically lockable plug connection with a built-in plug connector matched to the cable plug connector (1) as a counterpart, wherein the cable plug connector (1) comprises:
a plug body (2), comprising
a coupling portion (3), wherein the coupling portion (3) is provided to be inserted into an opening of the built-in plug connector to provide the plug connection; and
a receiving cavity (4) extending in an outer wall (5) of the plug body (2), wherein the receiving cavity (4) is configured as a half-shell with a passage (12) to an interior (6) of the plug body (2); and
a mechanical retaining element (7) comprising a locking part (9), an actuating part (10) and a connecting part (11) connecting the locking part (9) with the actuating part (10), wherein the mechanical retaining element (7) is arranged in the receiving cavity (4) such that
the actuating part (10) protrudes from the receiving cavity (4) in a direction perpendicular to a center axis (17) of the plug body (2); and
the connecting part (11) extends through the passage (12) of the plug
body (2), so that the locking part (9) is located in the interior (6) of the plug body (2).

2. The cable plug connector (1) according to claim 1, wherein the mechanical retaining element (7) is configured to provide a locking mechanism in that the locking part (9) engages in a retaining element counterpart of the built-in plug connector and is blocked with respect to an axial movement in a cable plug connector (1) extraction direction.

3. The cable plug connector (1) according to claim 1, wherein the mechanical retaining element (7) is arranged in the receiving cavity (4) such that the connecting part (11) rests with a side (16) facing the interior (6) of the plug body (2) on a first edge (14) formed by a bottom (13) of the receiving cavity (4) and the passage (12), so that the mechanical retaining element (7) is pivotable about a contact point (15) of the side (16) of the connecting part (11) with the first edge (14).

4. The cable plug connector (1) according to claim 3, wherein the mechanical retaining element (7) is pivotable about the contact point (15) such that at least one of:
a) if the actuating part (10) is pressed towards the receiving cavity (4), the locking part (9) is moved further away from the center axis (17) of the plug body (2) and closer to an inner wall (8) of the interior (6) of the plug body (2);
b) if the locking part (9) is pressed further away from the center axis (17) of the plug body (2) and closer to the inner wall (8) of the interior (6) of the plug body (2), the actuating part (10) is moved towards the receiving cavity (4);
c) if the actuating part (10) is raised from the receiving cavity (4), the locking part (9) is moved further away from the inner wall (8) of the interior (6) of the plug body (2) and closer to the center axis (17) of the plug body (2); or
d) if the locking part (9) is moved further away from the inner wall (8) of the interior (6) of the plug body (2) and closer to the center axis (17) of the plug body (2), the actuating part (10) is raised from the receiving cavity (4).

5. The cable plug connector (1) according to claim 4, wherein the connecting part (11) comprises on a side (19) facing away from the interior (6) of the plug body (2) an elevation (18), and the mechanical retaining element (7) is arranged in the receiving cavity (4) such that the elevation (18) rests on a second edge (42) formed by the inner wall (8) of the interior (6) of the plug body (2) and the passage (12), so that at least one of:
a) the mechanical retaining element (7) is blocked with respect to a movement in axial direction of the center axis (17) of the plug body (2) towards the coupling portion (3); or
b) a range of a pivoting movement of the mechanical retaining element (7) around the contact point (15) is limited.

6. The cable plug connector (1) according to claim 4, wherein the cable plug connector (1) further comprises a fastening element (21) configured to fasten the mechanical retaining element (7) in its arrangement in the receiving cavity (4), wherein the fastening element (21) passes through the receiving cavity (4) perpendicular to an axial direction of the center axis (17) of the plug body (2), so that
a) the mechanical retaining element (7) is positioned between the bottom (13) of the receiving cavity (4) and the fastening element (21); and
b) a range of a pivoting movement of the mechanical retaining element (7) around the contact point (15) is limited.

7. The cable plug connector (1) according to claim 1, further comprising: a covering element (20) arranged on the outer wall (5) of the plug body (2), the covering element (20) covers the receiving cavity (4) and the passage (12) to the interior (6) of the plug body (2) such that a penetration of water and/or gas from an area outside the cable plug connector (1) through the passage (12) into the interior (6) of the plug body (2) is prevented.

8. The cable plug connector (1) according to claim 7, wherein the covering element (20) comprises an elastically deformable material.

9. The cable plug connector (1) according to claim 1, further comprising: a plug insert (25) arranged in the interior (6) of the plug body (2), the plug insert (25) is provided to accommodate a contact element, and the contact element is provided to contact a contact element counterpart on the built-in plug connector side by entering the plug connection and thus to provide signal transmission over the plug connection, wherein the plug insert (25) is configured such that the cable plug connector (1) comprises one of the following cable plug connector types:
a two-pole or three-pole or four-pole power plug connector,
SPE,
USB-C,
IEC,
XLR,
RJ45,
HDMI,
USB,
RCA, or
Fiber Optical Ferrule.

10. The cable plug connector (1) according to claim 9, further comprising: a fixation unit (22) arranged in the interior (6) of the plug body (2), the fixation unit (22) is configured to fix the plug insert (25) and/or a cable contacted with the contact element received by the plug insert (25) in the interior (6) of the plug body (2).

11. The cable plug connector (1) according to claim 1, further comprising: a union nut (23) arranged at the plug body (2) at an end (24) of the plug body (2) opposite the coupling portion (3) in axial direction of the center axis (17) of the plug body (2), and the union nut (23) comprises a thread (26) on an outer wall of the union nut (23).

12. The cable plug connector (1) according to claim 1, further comprising: a seal (27) including a cable passage (28) that extends through the seal (27).

13. The cable plug connector (1) according to claim 12, wherein the seal (27) is arranged at an end (29) of the union nut (23) opposite a contact area of the union nut (23) with the plug body (2) in axial direction of the center axis (17) of the plug body (2).

14. The cable plug connector (1) according to claim 11, further comprising: a bushing (30) configured such that, if the bushing (30) is screwed onto the thread (26) of the union nut (23) and if a cable is passed through the cable passage (28) of the seal (27), the bushing (30) presses on the seal (27) so that the seal (27) is contacted with the cable passed through the cable passage (28).

15. The cable plug connector (1) according to claim 1, further comprising: a tensioning element (31) that exerts such a pretension on the mechanical retaining element (7) that the actuating part (10) protrudes from the receiving cavity (4) in the direction perpendicular to the center axis (17) of the plug body (2).

16. The cable plug connector (1) according to claim 15, wherein the receiving cavity (4) comprises a dividing wall (32) which separates the receiving cavity (4) into two parts (33, 34), wherein
a first of the two parts (33, 34) of the receiving cavity (4) which is more distant from the coupling portion (3) in the axial direction of the center axis (17) of the plug body (2), comprises the tensioning element (31); and
a second of the two parts (33, 34) of the receiving cavity (4), which is less distant from the coupling portion (3) in the axial direction of the center axis (17) of the plug body (2), comprises the passage (12) to the interior (6) of the plug body (2).

17. The cable plug connector (1) according to claim 16, wherein the mechanical retaining element (7) is arranged in the second of the two parts (33, 34) of the receiving cavity (4).

18. The cable plug connector (1) according to claim 4, further comprising: a tensioning element (31) that exerts such a pretension on the mechanical retaining element (7) that the actuating part (10) protrudes from the receiving cavity (4) in the direction perpendicular to the center axis (17) of the plug body (2);
the receiving cavity (4) comprises a dividing wall (32) which separates the receiving cavity (4) into two parts (33, 34), wherein
a first of the two parts (33, 34) of the receiving cavity (4) which is more distant from the coupling portion (3) in the axial direction of the center axis (17) of the plug body (2), comprises the tensioning element (31); and
a second of the two parts (33, 34) of the receiving cavity (4), which is less distant from the coupling portion (3) in the axial direction of the center axis (17) of the plug body (2), comprises the passage (12) to the interior (6) of the plug body (2); and
the tensioning element (31) extends from the bottom (14) of the receiving cavity (4) into a recess (35) of the actuating part (10) such that the tensioning element (31) abuts against a bottom of said recess (35), so that the pretension is exerted on the mechanical retaining element (7), wherein by applying pressure on the actuating part (10), the tensioning element (31) is compressible such that the actuating part (10) is adapted to be moved towards the receiving cavity (4), so that the locking part (9) is moved further away from the center axis (17) of the plug body (2) and closer to the inner wall (8) of the interior (6) of the plug body (2), so that, if the locking part (9) engages in the retaining element counterpart, the locking part (9) is moved out of the retaining element counterpart.
